(19) United States
(12) Patent Application Publication
(10) Pub. No.: US 2015/0006718 A1
(43) Pub. Date: Jan. 1, 2015

(54) TRANSMISSION MANAGEMENT DEVICE, SYSTEM, AND METHOD

(71) Applicant: POWER-ALL NETWORKS LIMITED, Shatin (HK)

(72) Inventor: STEVE LAP WAI HUI, Shatin (HK)

(21) Appl. No.: 14/315,588

(22) Filed: Jun. 26, 2014

(30) Foreign Application Priority Data
Jun. 27, 2013 (CN) 2013102618466

(51) Int. Cl. H04L 12/26

(52) U.S. Cl. CPC H04L 43/0888
USPC 709/224

(57) ABSTRACT

In a transmission management method, a network bandwidth of a transmission path between a first electronic device and a second electronic device is detected when the first electronic device transmits a media file to the second electronic device via the transmission path. The detected network bandwidth is compared to a reference network bandwidth. A leased transmission path is established between the first electronic device and the second electronic device when the detected network bandwidth is determined to be less than the reference network bandwidth. The first electronic device and the second electronic device are controlled to communicate with each other via the leased transmission path.

### CROSS-REFERENCE TO RELATED APPLICATIONS

This application claims priority to Chinese Patent Application No. 201310261846.6 filed on Jun. 27, 2013 in the China Intellectual Property Office, the contents of which are incorporated by reference herein.

1. “TRANSMISSION MANAGEMENT DEVICE, SYSTEM, AND METHOD” by Steve Lap Wai Hui, whose Attorney Docket No is US 52348.

2. “TRANSMISSION MANAGEMENT DEVICE, SYSTEM, AND METHOD” by Steve Lap Wai Hui, whose Attorney Docket No is US 52359.

3. “TRANSMISSION MANAGEMENT DEVICE, SYSTEM, AND METHOD” by Steve Lap Wai Hui, whose patent application is Ser. No. is 14/278640, filed on May 15, 2014, related to a method for establishing a leased/optimal transmission path.

4. “TRANSMISSION MANAGEMENT DEVICE, SYSTEM, AND METHOD” by Steve Lap Wai Hui, whose patent application Ser. No. is 14/278640, filed on May 15, 2014, related to a method for establishing a leased/optimal transmission path.

5. “TRANSMISSION MANAGEMENT DEVICE, SYSTEM, AND METHOD” by Steve Lap Wai Hui, whose patent application Ser. No. is 14/278685, filed on May 15, 2014, related to a method for establishing a leased/optimal transmission path.

6. “TRANSMISSION MANAGEMENT DEVICE, SYSTEM, AND METHOD” by Steve Lap Wai Hui, whose patent application Ser. No. is 14/278704, filed on May 15, 2014, related to a method for establishing a leased/optimal transmission path.

### FIELD

The present disclosure relates to devices, and particularly to a transmission management device, a system, and a method thereof.

### BACKGROUND

Electronic devices, such as mobile phones and tablet computers, can communicate with each other via corresponding networks, such as the Internet, a code division multiple access (CDMA) network, or a broadcasting network. A network bandwidth is assigned by a corresponding network operator to the electronic devices.

### BRIEF DESCRIPTION OF THE DRAWINGS

Implementations of the present technology will now be described, by way of example only, with reference to the attached figures.

FIG. 1 is a block diagram of an embodiment of a transmission management device.

FIG. 2 is a flowchart diagram of an embodiment of a transmission management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

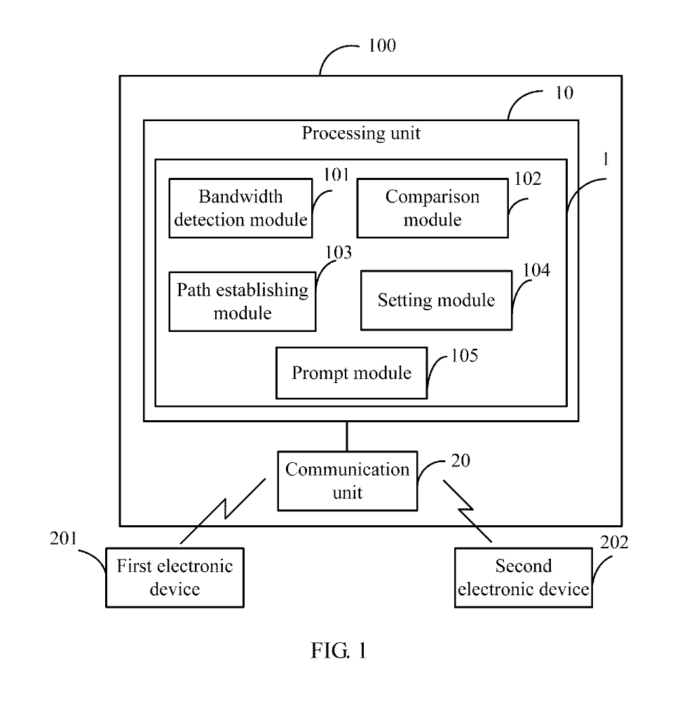

Referring to FIG. 1, a transmission management device 100 includes a processing unit 10 and a communication unit 20.

The transmission management device 100 connects to at least one first electronic device 201 and at least one second electronic device 202 via the communication unit 20. The communication unit 20 connects the transmission management device 100 to the first electronic device 201 and the second electronic device 202 via corresponding networks, such as the Internet, a wireless network (for example, WIFI or BLUETOOTH®), a telecommunication network (for example, a general packet radio service (GPRS) network or a code division multiple access (CDMA) network), or a broadcasting network.

In the embodiment, the processing unit 10 can run a transmission management system 1. The transmission management system 1 includes a number of modules which are a collection of software instructions and are executed by the processing unit 10 of the transmission management device 100. The modules include a bandwidth detection module 101, a comparison module 102, a path establishing module 103, a setting module 104, and a prompt module 105. In the embodiment, the processing unit 10 can be a central processing unit, a digital signal processor, or a single chip, for example.

The bandwidth detection module 101 detects a network bandwidth of a transmission path between the first electronic device 201 and the second electronic device 202, when the first electronic device 201 and the second electronic device 202 communicate with each other via the transmission path. In the embodiment, the first electronic device 201 is an initiator of communication with the second electronic device 202, and the first electronic device 201 can transmit a media file to the second electronic device 202. In another embodiment, the second electronic device 202 is the initiator of communication with the first electronic device 201, and the second electronic device 202 can transmit a media file to the first electronic device 201. The media file can be an audio file, a video file, a word file, an image, or the like.

The comparison module 102 compares the detected network bandwidth to a reference network bandwidth and judges whether the detected network bandwidth is less than the reference network bandwidth.

When the comparison module 102 determines that the detected network bandwidth is less than the reference network bandwidth, the path establishing module 103 establishes a leased transmission path between the first electronic device 201 and the second electronic device 202, and controls the first electronic device 201 and the second electronic device 202 to communicate with each other via the leased transmission path.

In the embodiment, the leased transmission path can be an on-demand virtual lease line (ODVLL) with a high network bandwidth. In more detail, the leased transmission path are constituted by a number of routers (not shown) connected between the first electronic device 201 and the second electronic device 202. The related technology of establishing the leased transmission path by the path establishing module 103 disclosed in the prior patent applications whose are patent application Ser. Nos. 14/278640, 14/278640, 14/278685, and 14/278704.

In the embodiment, the reference network bandwidth is determined by the comparison module 102 according to a data size of the media file transmitted by the first electronic device 201 and a predetermined time. For example, assuming that the data size of the media file is D, and the predetermined time is t, the comparison module 102 determines the reference network bandwidth according to the formula D/t. Therefore, if the data size is 100 Megabits, and the predetermined time is 10 seconds (s), then the reference network bandwidth is 10 Megabits/s. In another embodiment, the reference network bandwidth can be predetermined and can have a constant value, such as 10 Megabits/s.

In the embodiment, a user of the first electronic device 201 and a user of the second electronic device 202 can preset a desired transmission time for transmitting any media file by producing a setting request.

The setting module 104 is used to set the desired transmission time of the first electronic device 201 and the desired transmission time of the second electronic device 202 in response to setting requests of the first electronic device 201 and the second electronic device 202. The setting request of the first electronic device 201 includes the desired transmission time for transmitting one media file that the user of the first electronic device 201 requests.

The setting request of the second electronic device 202 also includes the desired transmission time for transmitting one media file that the user of the second electronic device 202 requests. For example, the user of the first electronic device 201 may request to transmit the media file completely within 10s, and the user of the second electronic device 202 may request to transmit the media file completely within 20s.

The comparison module 102 further compares the desired transmission time of the first electronic device 201 to the desired transmission time of the second electronic device 202, and selects a lesser of the desired transmission times of the first electronic device 201 and the second electronic device 202 as the predetermined time.

Therefore, according to the present disclosure, the leased transmission path can provide a high network bandwidth, and can enable the media file to be transmitted completely within the desired transmission times of both the first electronic device 201 and the second electronic device 202.

When the comparison module 102 determines that the detected network bandwidth is less than the reference network bandwidth, the prompt module 105 is used to generate and transmit a prompt signal to the first electronic device 201 to prompt a user of the first electronic device 201 whether to use the leased transmission path. The path establishing module 103 establishes the leased transmission path between the first electronic device 201 and the second electronic device 202 when the user of the first electronic device 201 selects to use the leased transmission path. In another embodiment, the prompt module 105 can be omitted.

In the embodiment, the path establishing module 103 is further used to disable the leased transmission path between the first electronic device 201 and the second electronic device 202 after the media file has been transmitted to the second electronic device 202 completely. In the embodiment, the path establishing module 103 further records a start time of establishing the leased transmission path, and an end time of disabling the leased transmission path.

In the embodiment, the transmission management device 100 can be a server of a network operator.

In another embodiment, the transmission management device 100 can be a server of a social network application. When the first electronic device 201 transmits the media file to the second electronic device 202 via the social network application, the modules of the transmission management system 1 execute the above-described functions to enhance the speed of transmitting the media file.

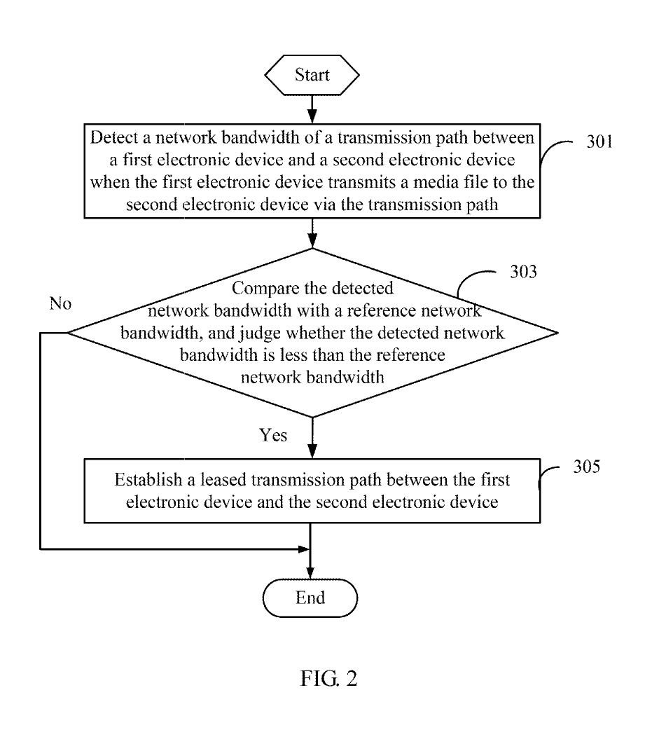

FIG. 2 illustrates a flowchart of a transmission management method.

In block 301, a bandwidth detection module detects a network bandwidth of a transmission path between a first electronic device and a second electronic device when the first electronic device and the second electronic device communicate with each other via the transmission path. In the embodiment, the first electronic device can transmit a media file to the second electronic device.

In block 303, a comparison module compares the detected network bandwidth to a reference network bandwidth and judges whether the detected network bandwidth is less than the reference network bandwidth. If the detected network bandwidth is less than the reference network bandwidth, block 305 is implemented. If the detected network bandwidth is not less than the reference network bandwidth, the process is ended.

In block 305, a path establishing module establishes a leased transmission path between the first electronic device and the second electronic device and controls the first electronic device and the second electronic device to communicate with each other via the leased transmission path.

In the embodiment, the method can further include: the path establishing module disables the transmission path between the first electronic device and the second electronic device when the media file is transmitted completely.

In the embodiment, the method can further include: a prompt module transmitting a prompt signal to the first electronic device to prompt a user of the first electronic device whether to use the leased transmission path when the comparison module determines that the detected network bandwidth is less than the reference network bandwidth. The path establishing module establishes the leased transmission path between the first electronic device and the second electronic device when the user of the first electronic device 201 selects to use the leased transmission path.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A transmission management system, applied to a transmission management device comprising a communication unit for connecting to at least one first electronic device and at least one second electronic device, the transmission management system comprising:
a processing unit; and
a plurality of modules which are collections of instructions executed by the processing unit, the modules comprising:
a bandwidth detection module configured to detect a network bandwidth of a transmission path between a first electronic device and a second electronic device when the first electronic device transmits a media file to the second electronic device via the transmission path;
a comparison module configured to compare the detected network bandwidth to a reference network bandwidth, and judge whether the detected network bandwidth is less than the reference network bandwidth; and
a path establishing module configured to establish a leased transmission path between the first electronic device and the second electronic device and control the first electronic device and the second electronic device to communicate with each other via the leased transmission path when the comparison module determines the detected network bandwidth is less than the reference network bandwidth.

2. The system according to claim 1, wherein the comparison module is further configured to determine the reference network bandwidth according to a data size of the media file transmitted by the first electronic device and a predetermined time.

3. The system according to claim 2, further comprising a setting module configured to set a desired transmission time of the first electronic device and a desired transmission time of the second electronic device in response to setting requests of the first electronic device and the second electronic device; wherein the comparison module further compares the desired transmission times of the first electronic device and the desired transmission time of the second electronic device, and select a lesser of the desired transmission times the first electronic device and the second electronic device as the predetermined time.

4. The system according to claim 3, wherein the setting request of the first electronic device comprises the desired transmission time for transmitting one media file that the user of the first electronic device requests; the setting request of the second electronic device comprises the desired transmission time for transmitting one media file that the user of the second electronic device requests.

5. The system according to claim 1, further comprising a prompt module configured to transmit a prompt signal to the first electronic device to prompt a user of the first electronic device whether to use the leased transmission path when the comparison module determines the detected network bandwidth is less than the reference network bandwidth; wherein the path establishing module establishes the transmission path between the first electronic device and the second electronic device when the user of the first electronic device selects to use the leased transmission path.

6. A transmission management device comprising:
a communication unit configured to communicate with at least one first electronic device and at least one second electronic device; and
a processing unit configured to execute a plurality of modules which are a collection of instructions, the modules comprising:
a bandwidth detection module configured to detect a network bandwidth of a transmission path between a first electronic device and a second electronic device when the first electronic device transmits a media file to the second electronic device via the transmission path;
a comparison module configured to compare the detected network bandwidth with a reference network bandwidth, and judge whether the detected network bandwidth is less than the reference network bandwidth; and
a path establishing module configured to establish a leased transmission path between the first electronic device and the second electronic device and control the first electronic device and the second electronic device to communicate with each other via the leased transmission path when the comparison module determines the detected network bandwidth is less than the reference network bandwidth.

7. The device according to claim 6, wherein the comparison module is further configured to determine the reference network bandwidth according to a data size of the media file transmitted by the first electronic device and a predetermined time.

8. The system according to claim 7, wherein the modules further comprise a setting module configured to set a desired transmission time of the first electronic device and a desired transmission time of the second electronic device in response to setting requests of the first electronic device and the second electronic device; the comparison module further compares the desired transmission time of the first electronic device and the desired transmission time of the second electronic device, and select a lesser of the desired transmission times the first electronic device and the second electronic device as the predetermined time.

9. The device according to claim 8, wherein the setting request of the first electronic device comprises the transmission time for transmitting one media file that the user of the first electronic device requests; the setting request of the second electronic device comprises the transmission time for transmitting one media file that the user of the second electronic device requests.

10. The device according to claim 6, wherein the modules further comprise a prompt module configured to transmit a prompt signal to the first electronic device to prompt a user of the first electronic device whether to use the leased transmission path when the comparison module determines the detected network bandwidth is less than the reference network bandwidth; wherein the path establishing module establishes the transmission path between the first electronic device and the second electronic device when determining the user of the first electronic device responds to use the leased transmission path.

11. A transmission management method comprising:
detecting a network bandwidth of a transmission path between a first electronic device and a second electronic device when the first electronic device transmits a media file to the second electronic device via the transmission path;
comparing the detected network bandwidth with a reference network bandwidth, and judging whether the detected network bandwidth is less than the reference network bandwidth; and
establishing a leased transmission path between the first electronic device and the second electronic device and controlling the first electronic device and the second electronic device to communicate with each other via the leased transmission path when determining the detected network bandwidth is less than the reference network bandwidth.

12. The method according to claim 11, further comprising:
determining the reference network bandwidth according to a data size of the media file transmitted by the first electronic device and a predetermined time.

13. The method according to claim 12, further comprising:
setting a desired transmission time of the first electronic device and a desired transmission time of the second electronic device in response to setting requests of the first electronic device and the second electronic device; and
comparing the desired transmission time of the first electronic device and the desired transmission time of the second electronic device, and selecting a lesser of the desired transmission times of the first electronic device and the second electronic device as the predetermined time.

14. The method according to claim 8, wherein the setting request of the first electronic device comprises the desired transmission time for transmitting one media file that the user of the first electronic device hopes; the setting request of the second electronic device comprises the desired transmission time for transmitting one media file that the user of the second electronic device hopes.

15. The method according to claim 11, further comprising:
transmitting a prompt signal to the first electronic device to prompt a user of the first electronic device whether to use the leased transmission path when the comparison module determines the detected network bandwidth is less than the reference network bandwidth.
